(19) United States
(12) Patent Application Publication
(10) Pub. No.: US 2003/0188044 A1
(43) Pub. Date: Oct. 2, 2003

(54) System and method for verifying superscalar computer architectures

(75) Inventors: Theodore J. Bohizic, Hyde Park, NY (US); Vincent L. Ip, Poughkeepsie, NY (US); Dennis W. Wittig, New Paltz, NY (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 10/113,756

(22) Filed: Mar. 28, 2002

(51) Int. Cl. G06F 9/00; G06F 9/46

(52) U.S. Cl. 709/328

(57) ABSTRACT

The invention relates to system and method for verifying a superscalar computer architecture. The system comprises a test program and an opcode biasing service comprising a bias table, a classification information structure, and a program opcode list. The system also comprises a configuration file describing the superscalar computer architecture. The configuration file stores bias definitions and opcodes grouped into classes based upon inherent rules of the superscalar computer architecture and is stored in a memory location accessible to the test program. The system also comprises an opcode biasing service application programming interface (API) operable for facilitating communication between the test program and opcode biasing service. The invention also includes a method and a storage medium for implementing opcode biasing services.

### CROSS REFERENCE TO RELATED APPLICATIONS

This application is related to co-pending applications entitled, “System and Method for Facilitating Programmable Coverage Domains for a Testcase Generator”, (Attorney Docket No. POU920020002US 1), and “System and Method for Facilitating Coverage Feedback Testcase Generation Reproducibility”, (Attorney Docket No. POU920020001US1) which were both filed on Mar. 28, 2002, and are incorporated herein by reference in their entireties

### FIELD OF THE INVENTION

This invention relates to computer processor verification and, more specifically, the invention relates to a method and system for generating test streams for verification and detection of faulty hardware implementing superscalar architectures.

### BACKGROUND OF THE INVENTION

Computer processor verification tools are used for testing new and existing hardware designs and prototypes. As newer computer architectures become available over time, verification tools must correspondingly adapt to meet the changing requirements of this hardware. In the past, verification programs were manually written utilizing test requirements derived from the architecture specification. Requirements include testing each instruction under normal, boundary, and exception conditions. As computer architectures evolved over time they became increasingly complex, making it difficult and expensive to continue with manually written testing programs. A typical architecture includes hundreds of instructions, dozens of resources, and complex functional units, and its description can be several hundred pages long. Automated test program generators were developed for testing these new and complex architectures by generating random or pseudo random test streams. Automated test program generators are typically complex software systems and can comprise tens of thousands of lines of code.

One drawback associated with automated test program generators is that a new test program generator must be developed and implemented for each architecture used for testing. Further, changes in the architecture or in the testing requirements necessitate that modifications be made to the generator's code. Since design verification gets under way when the architecture is still evolving, a typical test generation system may undergo frequent changes.

In automated test program generators, features of the architecture and knowledge gained from testing are modeled in the generation system. The modeling of the architecture is needed to define its features and elements in order to generate appropriate test cases. The modeling of the testing knowledge is used to further refine the testing process by building upon the knowledge acquired from previous testing. These architectural features and testing knowledge are then combined and embedded into the generation procedures. Modeling of both architecture and testing knowledge is procedural and tightly interconnected, thus, its visibility is low, which in turn, worsens the effects of its complexity and changeability.

Another solution provides a test program generator which is architecture independent. This is achieved by separating the knowledge from the control. In other words, an architecture-independent generator is used which extracts data stored as a separate declarative specification in which the processor architecture is appropriately modeled. The test program generator then creates random test streams for hardware verification. While effective in some types of hardware, this solution may not comport with larger, more complex superscalar architectures which, by virtue of their design, demand more precise testing techniques.

The term, “superscalar” describes a computer implementation that improves performance by concurrent execution of scalar instructions. This is achieved through multiple execution units working in parallel. In order to obtain this performance increase, sophisticated hardware logic is needed to decode the instruction stream, decide where to run specified instructions, etc.. Superscalar design relies closely on the micro architecture used to carry out a particular instruction. For example, certain classes of instructions can be run in parallel with others, while other classes must be run by themselves. To properly test these instructions, a test program would have to, at a minimum, classify instructions based on the underlying superscalar architecture.

It would be desirable to enhance existing test programs to create test streams better suited for testing both existing and future superscalar architectures.

### SUMMARY OF THE INVENTION

The invention relates to an enhanced system and method for verifying a superscalar computer architecture. The system comprises a test program and an opcode biasing service comprising a bias table, a classification information structure, and a program opcode list. The system also comprises a configuration file describing the superscalar computer architecture. The configuration file stores bias definitions and opcodes grouped into classes based upon inherent rules of the superscalar computer architecture and is stored in a memory location accessible to the test program. The system also comprises an opcode biasing service application programming interface (API) operable for facilitating communication between the test program and opcode biasing service. The invention also includes a method and a storage medium for implementing opcode biasing services.

The above-described and other features and advantages of the present invention will be appreciated and understood by those skilled in the art from the following detailed description, drawings, and appended claims.

### BRIEF DESCRIPTION OF THE DRAWINGS

FIG. 1 illustrates an exemplary block diagram of an enhanced system for generating pseudo-random test streams used in verifying superscalar architectures;

FIG. 2 illustrates a sample configuration file for describing a superscalar architecture in an exemplary embodiment of the invention;

FIG. 3 illustrates program code for a sample application programming interface used by the opcode biasing service tool in an exemplary embodiment of the invention; and

FIG. 4 is a flowchart illustrating the process of generating an opcode utilizing the opcode biasing service tool in an exemplary embodiment.

### DETAILED DESCRIPTION OF THE INVENTION

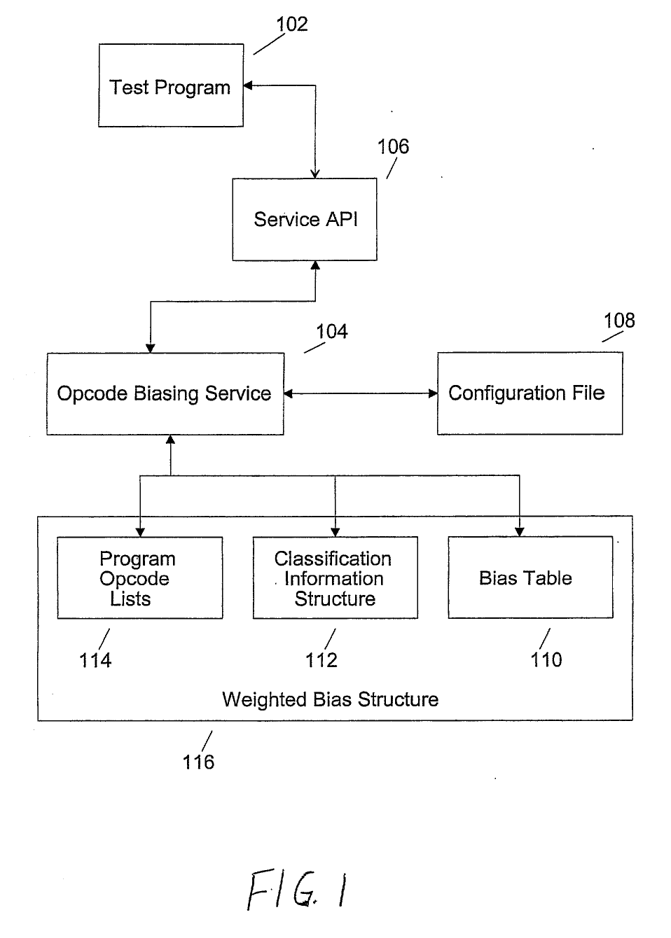

FIG. 1 depicts the elements that comprise a system enabled for opcode biasing enhanced by the present invention. The elements include a test program 102, an opcode biasing service structure 104 (also referred to as ‘service’ 104) including an API 106, and a configuration file 108. In order to keep implementation details away from a test program, the code is placed into a service module 104 and the configuration details are stored in a separate file 108. It will be understood that a number of configuration files may exist, each describing a particular architecture. For purposes of illustration, however, only one configuration file 108 is shown. Configuration file 108 descriptions reflect the characteristics of the hardware and therefore contain a classification for every opcode available to the architecture or at a minimum, every opcode in which the tester is interested in. Configuration file 108 preferably contains information as to how these opcode classifications should be distributed to best exercise the hardware facilities. This can be accomplished via a bias section included in configuration file 108. The service 104 comprises a bias table 110 that embodies the bias information extracted from configuration file 108. This bias information is used by service 104 to take a pseudo-randomly generated number and then transform it into an opcode based on the biasing definition. This could be implemented with arrays, multi-level linked lists, or other suitable mechanisms. The service 104 also includes a classification information structure 112 for retaining the classification information gained from configuration file 108. This structure 112 would be used to quickly look up the classification data for any opcode defined in configuration file 108. This can be implemented using arrays, b-trees, hash tables, etc.. A test program 102 may not need every opcode available to the architecture in its test stream. Accordingly, test program 102 provides information through API 106 about which opcodes to use. Opcode information relevant to test program 102 are stored in program opcode lists 114. These opcode lists 114 contain the opcodes which test program 102 will randomly choose from when generating its test streams. Program opcode lists 114, classification information 112, and bias table 110 are used concurrently by opcode biasing service 104 to create a weighted bias structure 116.

In order to maximize the verification of computer architectures implementing superscalar instruction execution, pseudo-random test streams utilize that certain test instructions clustered into large groups. Since superscalar architectures use multiple execution units to perform more than one instruction per clock cycle, larger groupings of superscalar opcodes would keep more stress on the hardware. The architecture may also employ buffers and read ahead logic which would prepare data to be processed quickly. Larger groups would enable testing the limits of these buffers, the read ahead logic, and exercising the related hardware extensively. In order to achieve this result without drastically changing an existing base of test programs, a description of the superscalar architecture which conforms to pseudo-random test generation techniques, along with a service implementation which supports the description, is provided. The description file (also referred to as ‘configuration file’), groups opcodes into different classes based on the inherent rules of the underlying microarchitecture to be tested. The configuration file also contains a weighted biasing feature which allows a designer to control the overall mix of the resultant opcode stream. An application programming interface (API) is also provided via the service for enabling a test tool builder to implement this invention into test programs. With the proper calls, the generated test stream results in a mix of opcodes characteristic of the bias definition found in the configuration file.

Service 104 includes program code for extracting bias information from a configuration file such as file 108 and transforming the bias information into an opcode. The service's API 106 enables communication between service 104 and test program 102. API 106 provides a structured interface in which the test program 102 can inform the service 104 of such things as where a configuration file is located, combining program opcodes with service structures, and allowing test program 102 to query service 104 for an opcode as described further herein.

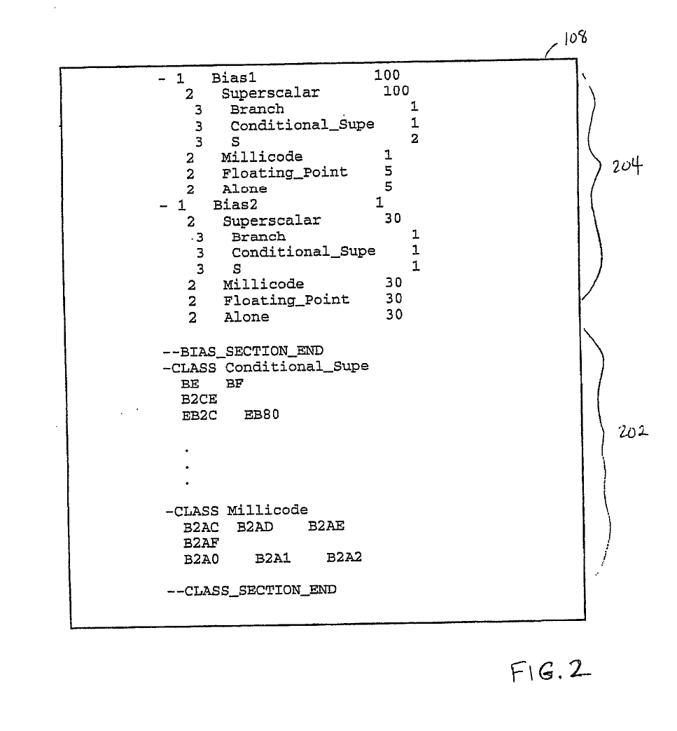

FIG. 2 illustrates the layout of a sample configuration file. Configuration files may be set up by a superscalar architect or similar professional. For creation of good test streams, a configuration file needs to be consistent with the underlying microarchitecture and should allow for special conditions and limits within the architecture to be tested. Because configuration files describe the underlying superscalar architecture design, a test program implementing service 104 would not need to know all of the details of the architecture. Configuration file 108 specifies special conditions to be tested and includes a description of the biases assigned to each opcode class. Configuration file 108 also stores opcode classifications.

Configuration file 108 contains an opcode classification section 202 and a bias definition section 204 where categories can be given relative weights. In the sample file of FIG. 2, the bias section 204 appears at the top of file 108 and the classification section 202 follows. Classification section 202 classifies the opcodes into named classes. FIG. 2 illustrates two classes in classification section 202, namely, “Conditional_Supe” and “Millicode”. The opcodes classified under the “Conditional_Supe” heading include “BE”, “BF”, “B2CE”, “EB2C”, and “EB80”. These opcode groupings and classes are provided for illustrative purposes and are not exhaustive. Configuration file 108 is stored in a memory location accessible to test program 102 implementing the service.

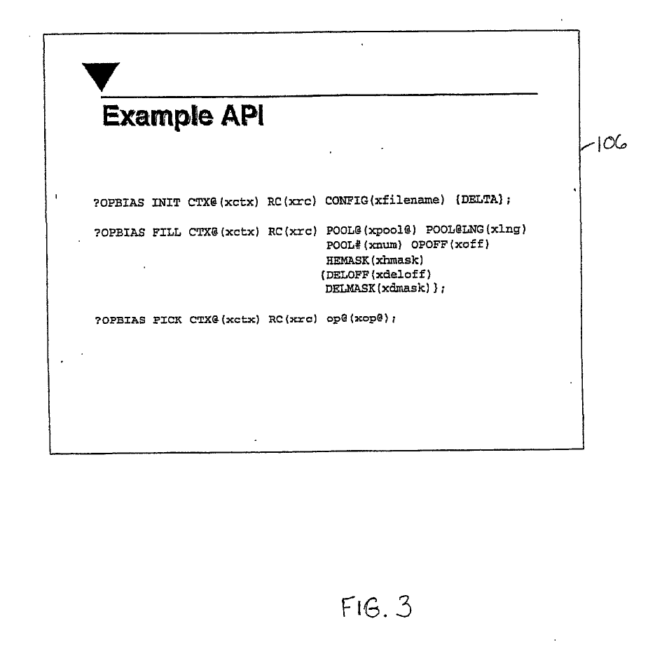

FIG. 3 illustrates sample API code for implementing the opcode biasing service tool functions described above. API 106 contains the functions necessary to interface with test program 102. API 106 contains a call to inform service 104 where configuration file 108 is. Also, since test programs may test only a subset of the total opcodes available to the architecture, another call is needed to allow service 104 to combine program structures which point to the program selected opcode pool with the appropriate service structures. Finally, a call that allows program 102 to query service 104 to pick and return an opcode is provided.

The code utilized by API 106 as shown in FIG. 3 is created in PLX Macro (^{SM}) language. The “ENIT” macro 302 is used for telling service 104 where configuration file 108 is located. The “FILL” macro 304 takes the information gathered from configuration file 108 and applies it to the structures which the implementing program holds. Lastly, the “PICK” macro 306 queries service 104 for an opcode, which service 104 chooses in a weighted pseudo-random manner. Although the code used in implementing API 106 is PLX Macro (^{SM}) language, it will be noted that any suitable software language may be used as appropriate.

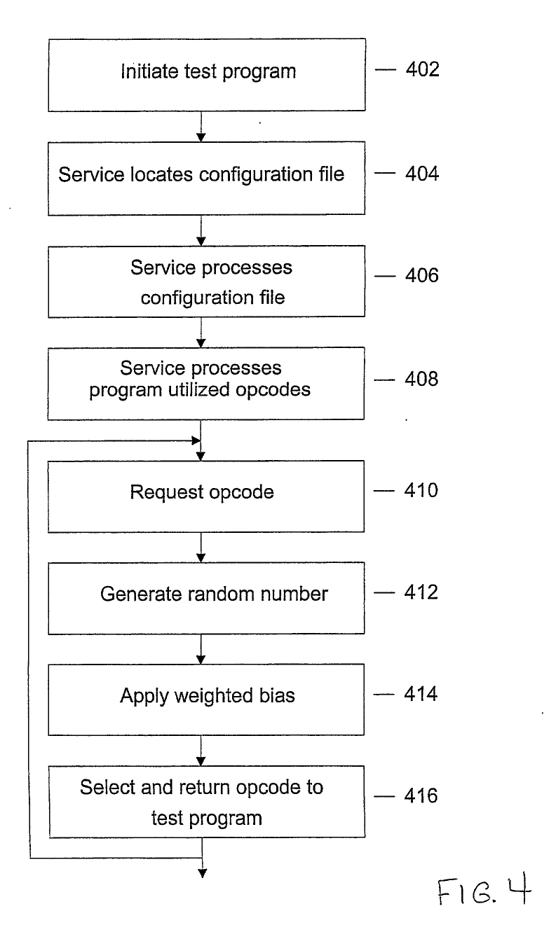

FIG. 4 illustrates a process flow whereby test program 102 accesses opcode biasing service 104 for generating an opcode test stream. Test program 102 is initiated at step 402. Test program 102 accesses API 106 and initiates a request to service 104 to initialize itself. In step 404, service 104 locates the configuration file 108 associated with the architecture being tested. The location of configuration file 108 is preferably provided to the service by test program 102 through API 106. The test program itself may have the location of the file hard coded into itself or have it as a parameter passed in by the operator. Description information is retrieved from configuration file 108 by API 106 and transmitted to opcode biasing service 104 at step 406. The opcodes that test program 102 is interested in are fed through API 106 to service 104 at step 408. A request is then made by test program 102 through API 106 for an opcode at step 410. Service 104 includes a mechanism for generating random numbers used for selecting opcodes from the pool of available opcodes. A random number is generated at step 412. A weighted bias algorithm is applied according to criteria provided in configuration file 108 at step 414. The weighted bias opcode is selected and returned to test program 102 at step 416. Steps 410 through 416 may be repeated a number of times in order to create a test stream of opcodes for testing.

The opcode biasing service tool allows greater flexibility in utilizing test programs through classification and weighted biasing techniques, which in turn, enables an operator control in the overall composition of the test stream. The biasing service interface further simplifies the testing process because the test programmer does not need to know of the classification criteria or deal with the user-specified weights.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. An system for verifying a superscalar computer architecture, comprising:
a test program;
an opcode biasing service comprising:
a bias table;
a classification information structure; and
a program opcode list;
a configuration file describing said superscalar computer architecture, said configuration file stored in a memory location accessible to said test program; and
an opcode biasing service application programming interface (API) operable for facilitating communication between said test program and said opcode biasing service.

2. The system of claim 1, wherein said configuration file stores an opcode classification section including opcodes grouped into classes based upon inherent rules of said superscalar computer architecture.

3. The system of claim 1, wherein said configuration file stores a bias definition section operable for assigning weights to opcode classes.

4. The system of claim 1, wherein said bias table stores bias information extracted from said configuration file for use by said opcode biasing service.

5. The system of claim 1, wherein said classification information structure stores classification information extracted from said configuration file, said classification information structure used to look up classification data for opcodes provided in said configuration file.

6. The system of claim 1, wherein said program opcode list stores opcode information relevant to said test program.

7. The system of claim 1, wherein said bias table, said classification information structure, and said program opcode list are used concurrently by said opcode biasing service and said API for customizing selection of a resulting opcode stream.

8. The system of claim 1, wherein said opcode biasing service API includes instructions for:
informing said test program where said configuration file is located;
combining program structures related to said test program with service structures related to said opcode biasing service, said program structures pointing to a program selected opcode pool; and
allowing said test program to query said opcode biasing service for an opcode.

9. The system of claim 1, wherein said opcode biasing service includes a means for generating a random number for selecting an opcode.

10. A method for verifying a superscalar computer architecture via a test program, comprising:
initiating said test program;
receiving a request to access an opcode biasing service API by said test program;
initializing an opcode biasing service;
locating a configuration file associated with said superscalar computer architecture;
retrieving description information from said configuration file;
transmitting said description information to said opcode biasing service;
receiving an opcode list from said test program;
receiving a request for an opcode from said test program;
generating a random number;
using said description information, applying a weighted bias algorithm to said random number resulting in a pseudo-random generated opcode; and
returning said pseudo-random generated opcode to said test program.

11. The method of claim 10, wherein said description information includes opcode classifications and bias definitions for opcodes.

12. A storage medium encoded with machine-readable computer program code for verifying a superscalar computer architecture via a test program executing on a computer, said storage medium including instructions for causing said computer to implement a method, comprising:
initiating said test program;
receiving a request to access an opcode biasing service API by said test program;
initializing an opcode biasing service;
locating a configuration file associated with said superscalar computer architecture;
retrieving description information from said configuration file;
transmitting said description information to said opcode biasing service;
receiving an opcode list from said test program;
receiving a request for an opcode from said test program;
generating a random number;
using said description information, applying a weighted bias algorithm to said random number resulting in a pseudo-random generated opcode; and
returning said pseudo-random generated opcode to said test program.

13. The storage medium of claim 12, wherein said description information includes opcode classifications and bias definitions for opcodes.
